(19) United States
(12) Patent Application Publication
(10) Pub. No.: US 2016/0061254 A1
(43) Pub. Date: Mar. 3, 2016

(54) BEARING ASSEMBLY AND METHOD FOR ASSEMBLING AND MOUNTING SAID BEARING ASSEMBLY WITH A COMPONENT SUPPORTING SAID BEARING ASSEMBLY

(71) Applicant: AKTIEBOLAGET SKF, Göteborg (SE)

(72) Inventors: Laurent Varnoux, Saint Avertin (FR); Olivier Verbe, Tours (FR)

(73) Assignee: AKTIEBOLAGET SKF, Göteborg (SE)

(21) Appl. No.: 14/780,924

(22) PCT Filed: Mar. 28, 2013
(86) PCT No.: PCT/EP2013/056739

§ 371 Date: Sep. 28, 2015

(51) Int. Cl. F16C 19/52; F16C 35/077; F16C 43/04; H02K 7/08

(52) U.S. Cl. CPC F16C 19/525; H02K 7/08; F16C 19/527; F16C 35/077; F16C 43/04

(57) ABSTRACT

A bearing assembly includes at least one ring arranged between first and second components, and the second component is mounted for rotation relatively to the first component. The bearing assembly includes at least one layer of expandable material disposed radially between a first ring of the at least one ring and one of the first and second components. The at least one layer of expandable material has been irreversibly expanded by heating it to a temperature above a first temperature threshold.

The present invention relates to bearings, in particular bearings having at least one ring. The bearings may be, for example, rolling bearings, bushing bearings or plain bearings used in industrial electric motors.

In particular, the present invention relates to rolling bearings having an inner ring and an outer ring with one or more rows of rolling elements held by a cage between raceways provided in the two rings. The rolling elements may, for example, be balls.

An electric motor generally comprises a casing inside which is mounted a stator and a rotor mounted for rotation relatively to the stator. Two bearings are supported by said stator and rotor, located at each end of the rotor's shaft.

In such applications, known ISO deep groove ball bearings are usually used. These bearings comprise inner and outer rings of the massive or solid type. A “solid ring” is to be understood as a ring obtained by machining with removal of material (by turning, grinding) from steel tube stock, bar stock, rough forgings and/or rolled blanks. Such rolling bearings are mainly loaded radially and have their inner rings mounted with a tight fit on the shaft of the rotor. The outer rings of the bearings are mounted in cylindrical housings of the motor's casing. Said casing is generally made in light alloy aluminium.

The expansion coefficient of the casing of the motor is higher than the expansion coefficient of the rings of the bearings. In case of a temperature increase, a clearance between the outer rings of the bearings and the cylindrical bore of the casing is created, which leads to a rotation of the outer rings of the bearings.

In order to avoid such rotation of the outer ring of the bearing, FR 2 835 580 discloses a rolling bearing comprising an inner ring and an outer ring with at least one row of rolling elements, and a expansion compensation ring mounted in a annular groove provided on the outer cylindrical surface of the outer ring of the rolling bearing.

However, during low temperature, such as 0° C., the expansion compensation ring is not in contact with the housing of the casing, the outer ring of the rolling bearing is thus not reliably fixed to the housing and may rotate compared to the housing.

It is a particular object of the present invention to provide a rolling bearing assembly having a ring permanently and reliably fixed to the housing and/or the shaft of the motor.

It is another object of the present invention to allow easy dissembling of the rolling bearing assembly out of the motor.

Finally, it is an object of the present invention to provide a rolling bearing assembly having damping properties.

In one embodiment, a bearing assembly comprises at least one ring arranged between two components supporting said bearing assembly, one component being mounted for rotation relatively to the other component.

The bearing assembly comprises at least one layer of expandable material radially disposed between said one ring and one of said components, said layer of expandable material having been expanded by a heat treatment until a second temperature threshold of deformation in a non-reversible way.

The layer of expendable material is thus deformed plastically in a non-reversible way and thus permanently deformed, so as to stay expanded, even under temperature variation. Said ring is thus radially assembled with the component to be assembled with

In one embodiment, said one ring comprises on one of its cylindrical surface at least one cylindrical groove. A layer of expandable material is disposed in said groove.

In another embodiment, said one ring comprises on one of its cylindrical surface at least two cylindrical grooves and a layer of expandable material is disposed in each said grooves.

Advantageously, the bearing assembly comprises rolling elements located between said one ring and the other component.

In an embodiment, the bearing assembly comprises an inner ring, an outer ring and rolling elements being disposed between raceways provided on said inner and outer rings.

A layer of expandable material may be disposed between the cylindrical surface of said one ring and the component to be assembled with so as to cover substantially the entire cylindrical surface of said one ring.

Advantageously, the layer of expandable material comprises a shell and a fluid encapsulated inside said shell. Said fluid has its internal pressure increased when the temperature reaches a first temperature threshold and said shell is deformed plastically in a non-reversible way when the temperature reaches a second temperature threshold and rupture when the temperature reaches a third temperature threshold.

For example, the first temperature threshold is comprised between 80° C. and 95° C., for example of 90° C., the second temperature threshold is comprised between 120° C. and 135° C., for example of 130° C., and the third temperature threshold is higher than 140° C., for example 200° C.

According to a second aspect, it is proposed an electric motor comprising a casing, a rotor mounted in rotation in said casing and at least one bearing assembly as described above arranged between the casing and the rotor.

According to another aspect, it is proposed a method of assembling a bearing assembly comprising at least one ring (arranged between two components supporting said bearing assembly, one component being mounted for rotation relatively to the other component, comprising the steps of positioning radially a layer of expandable material between at least one ring of said bearing assembly and the component to be assembled with and heating the layer of expandable material until a temperature threshold of deformation in a non-reversible way.

The present invention will be better understood from studying the detailed description of a number of embodiments considered by way of entirely non-limiting examples and illustrated by the attached drawings in which:

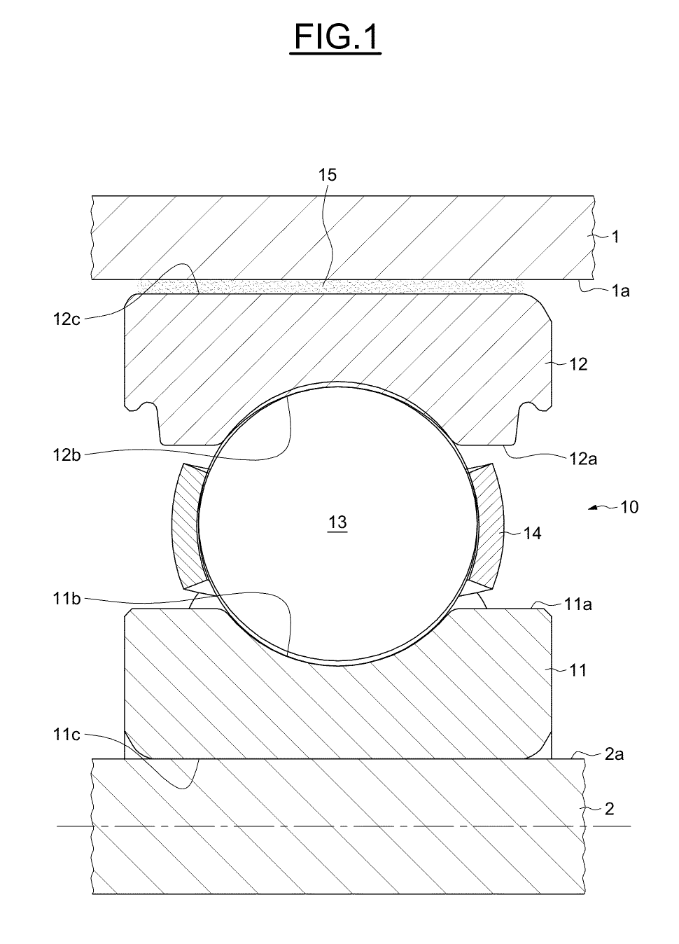

FIG. 1 is an axial half-section of the rolling bearing assembly according to a first embodiment of the invention mounted between two components of a motor;

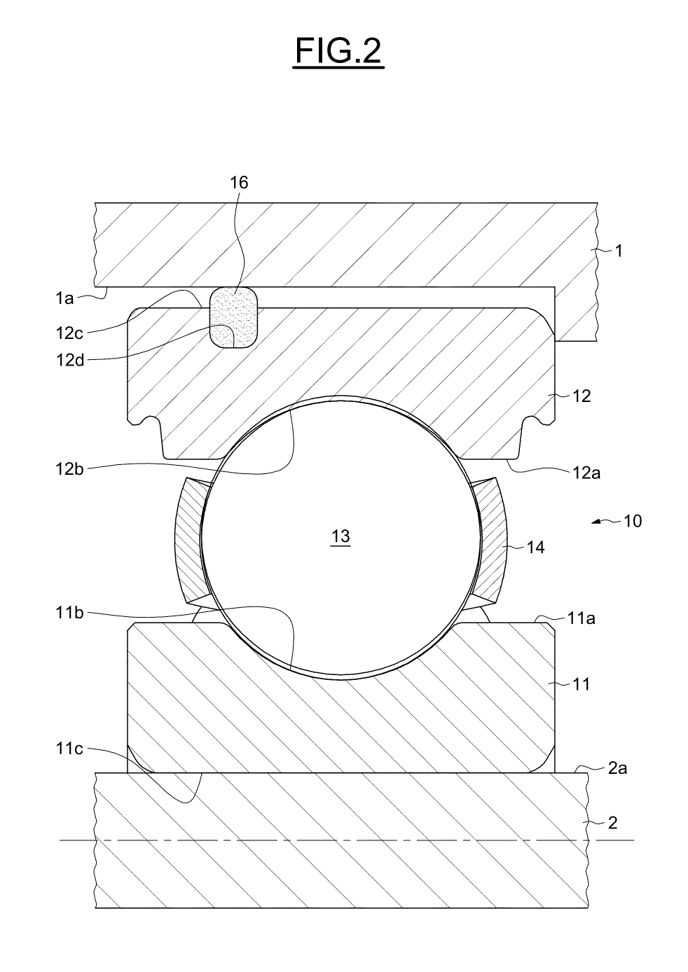

FIG. 2 is an axial half-section of the rolling bearing assembly according to a second embodiment of the invention;

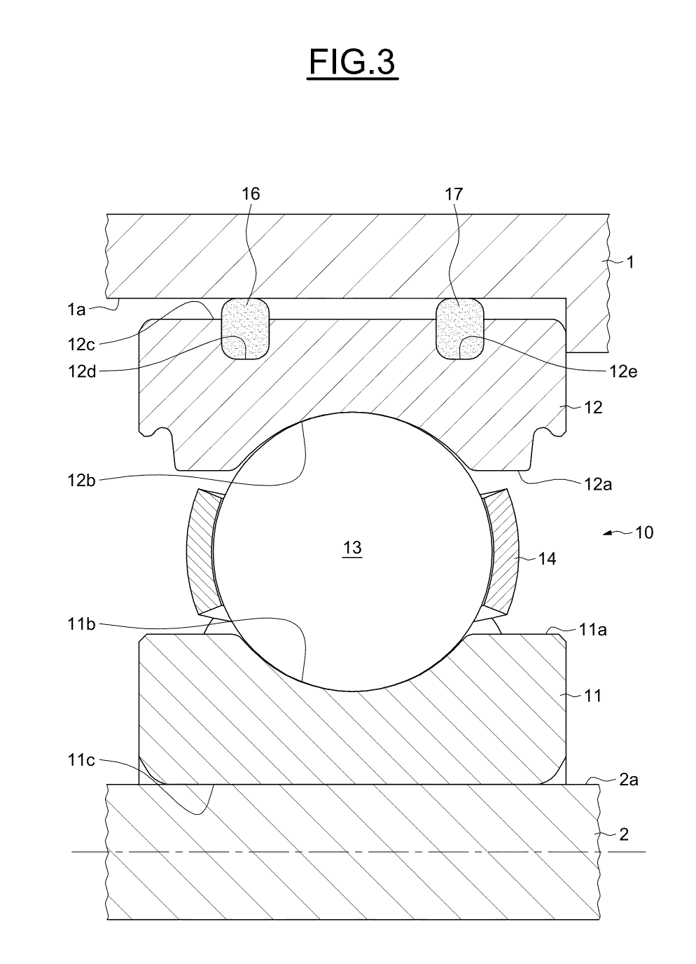

FIG. 3 is an axial half-section of the rolling bearing assembly according to a third embodiment of the invention;

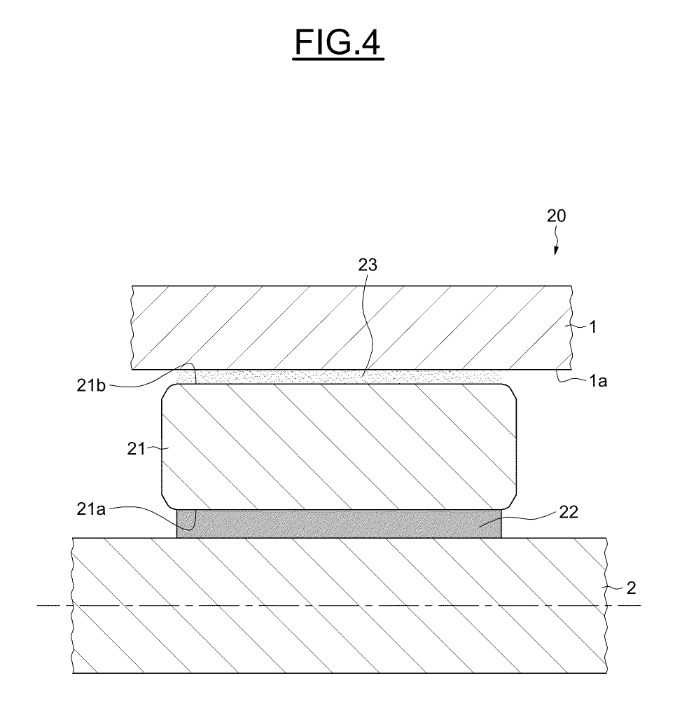

FIG. 4 is an axial half-section of the plain bearing assembly according to a fourth embodiment of the invention;

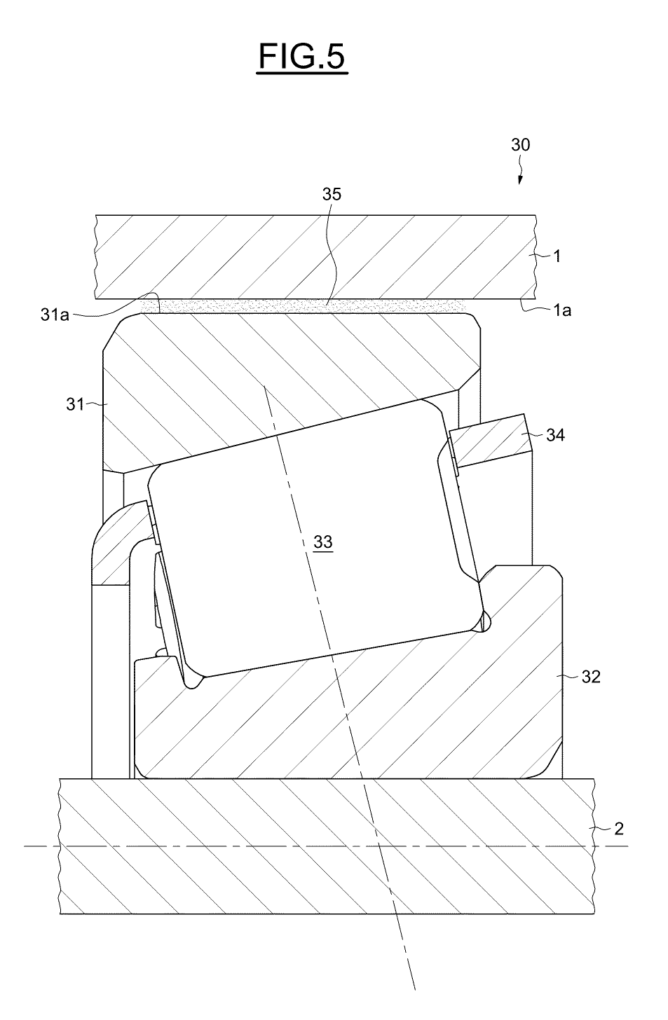

FIG. 5 is an axial half-section of the bushing bearing assembly according to a fifth embodiment of the invention.

As illustrated on FIGS. 1 to 3, a rolling bearing assembly, designed by general reference number 10, comprises an inner ring 11, an outer ring 12, a row of rolling elements 13 consisting, in the example illustrated, of balls, held by a cage 14 between the inner ring 11 and the outer ring 12.

The rolling bearing assembly 10 is designed to be mounted in an electric motor (not shown) having a casing inside which is mounted a stator and a rotor mounted for rotation relatively to the stator. As illustrated on the figures, the rolling bearing assembly 10 is designed to be supported by two mechanical components, such as for example the casing 1 of the electric motor and the shaft 2 of the rotor.

The inner ring 11 is solid and has on its outer cylindrical surface 11a a toroidal groove 11b, the radius of curvature of which is slightly greater than the radius of the rolling elements 13 and forms a bearing race for the rolling elements 13. The inner ring 11 may be manufactured by machining or by pressing a steel blank, which is then ground and optionally lapped at the bearing race 11b in order to give the ring 11 its geometrical characteristics and its final surface finish.

The outer ring 12 is solid and has on its inner cylindrical surface 12a a toroidal groove 12b, the radius of curvature of which is slightly greater than the radius of the rolling elements 13 and forms a bearing race for the rolling elements 13. The outer ring 12 may be manufactured by machining or by pressing a steel blank, which is then ground and optionally lapped at the bearing race 12b in order to give the ring 12 its geometrical characteristics and its final surface finish.

Alternatively, the outer and/or inner ring may comprise two half ring parts or half rings identical and symmetric with respect to the axial plane of symmetry of the bearing 10.

As illustrated, the rolling bearing assembly 10 comprises an annular layer 15 of expandable material radially located between the outer cylindrical surface 12c of the outer ring 12 and the cylindrical bore 1a of the casing 1. The layer 15 of expandable material is disposed so as to cover substantially the entire cylindrical surface 12c of said outer ring 12. Alternatively, the layer 15 of expandable material could be located between the inner cylindrical surface 11c of the inner ring 11 and the outer cylindrical surface 2a of the shaft's rotor and could cover a part of the cylindrical surface of the outer and/or inner ring.

The layer 15 is made of a material having the properties to expand when the temperature inside the bearing assembly 10 reaches a first temperature threshold T₁, such as for example between 80° C. and 95° C., for example of 90° C.

The layer 15 comprises a shell and a fluid, such as for example gas, encapsulated inside said shell. For example, the fluid particles can have a diameter comprised between 10 μm and 16 μm and have a density comprised between 5 kg/m³ and 15 kg/m³. Said fluid has its internal pressure increased when the temperature T reaches the first temperature threshold T₁ and expand the shell with the increase of temperature. The shell is deformed plastically in a non-reversible way when the temperature T reaches a second temperature threshold T₂ and rupture when the temperature T reaches a third temperature threshold T₃. The second temperature threshold T₂ is for example comprised between 120° C. and 135° C., for example of 130° C., and the third temperature threshold T₃ is, for example, higher than 200° C.

The bearing assembly 10 is assembled with the casing 1 or the shaft 2 as follows.

An annular layer 15 of expandable material is positioned radially between the outer cylindrical surface 12c of the outer ring 12 and the cylindrical bore 1a of the casing 1, so as to cover substantially the entire cylindrical surface 12c of said outer ring 12.

The bearing assembly 10 is then heated until the second temperature threshold T₂, so as to deform plastically the shell of the layer 15 of expandable material. The shell is thus permanently deformed and stay expanded, even when temperature decreases.

In order to disassemble the outer ring 12 of the rolling bearing 10 and the casing 1, temperature is increased to the third temperature threshold T₃. When the temperature reaches the third temperature threshold T₃, the shell of the layer 15 explodes and the outer ring 12 of the bearing assembly is disassembled with the casing 1.

In the embodiment of FIG. 2 in which identical elements bear the same references, differs from the embodiment of FIG. 1 only by the fact that the layer of expandable material have the shape of a toroidal ring 16 disposed in a cylindrical groove 12d provided on the cylindrical surface 12c of the outer ring 12. As an alternative, the layer 16 of expandable material may be disposed in a cylindrical groove provided on the cylindrical surface 11c of the inner ring 11.

In the embodiment of FIG. 3 in which identical elements bear the same references, differs from the embodiment of FIG. 2 only by the fact that the outer cylindrical surface 12c of the outer ring 12 is provided with two cylindrical grooves 12d, 12e. An expandable material toroidal ring 16, 17 is disposed in each cylindrical groove 12d, 12e. As an alternative, the layer 16 of expandable material may be disposed in cylindrical grooves provided on the cylindrical surface 11c of the inner ring 11.

Both layers 16, 17 are made of the same material having the property to expand when the temperature T reaches the first temperature threshold T₁, for example a temperature comprised between 80° C. and 95° C., for example of 90° C., to reach its plastically deformation when the temperature T reaches the second temperature threshold T₂, for example a temperature comprised between 120° C. and 135° C., for example of 130° C., and to rupture when the temperature reaches the third temperature threshold T₃, for example a temperature higher than 200° C. Both layers 16, 17 have the same thermal properties and characteristics as the layer 15 of FIG. 1.

The method of FIG. 1 is applied to the embodiments of FIGS. 2 and 3 for assembling and disassembling the bearing assembly 10 with the casing 1 or the shaft 2.

As illustrated on FIG. 4, in which identical elements bear the same references, a plain bearing assembly, designed by general reference number 20, comprises one ring 21 and a layer of dry lubrication 22 on the inner cylindrical surface 21a of the ring 21. As an alternative, the plain bearing assembly 20 may comprise an inner ring and an outer ring between which are disposed the layer of dry lubrication 22.

The plain bearing assembly 20 is designed to be supported by two mechanical components, such as for example the casing 1 of the electric motor and the shaft 2 of the rotor.

As illustrated, the plain bearing assembly 20 comprises an annular layer 23 of expandable material radially located between the outer cylindrical surface 21b of the ring 21 and the cylindrical bore 1a of the casing 1.

Alternatively, the layer 23 of expandable material could be located between the inner cylindrical surface 21a of the ring 21 and the outer cylindrical surface 2a of the shaft's rotor. In this case, the layer of dry lubrication 22 is disposed on the outer cylindrical surface 21b of the ring 21.

The layer 23 is made of a material having the properties to expand when the temperature T reaches the first temperature threshold T₁, for example a temperature comprised between 80° C. and 95° C., for example of 90° C., to reach its plastically deformation when the temperature reaches the second temperature threshold T₂, for example a temperature comprised between 120° C. and 135° C., for example of 130° C., and to rupture when the temperature reaches the third temperature threshold T₃, for example a temperature higher than 200° C.

As an alternative, the layer 23 may have the shape of a toroidal ring and be located in one or two grooves provided on the outer or inner surface of the ring.

The layer 23 has the same thermal properties and characteristics as the layer 15 of FIG. 1.

As illustrated on FIG. 5, in which identical elements bear the same references, a bushing bearing assembly, designed by general reference number 30, comprises an outer ring 31, an inner ring 32 and rolling elements 33, for example cylindrical elements, held by a cage 34 fixed to the outer ring 31. As an alternative, the bushing bearing assembly 30 may comprises only one outer ring 31 and rolling elements 33.

The bushing bearing assembly 30 is designed to be supported by two mechanical components, such as for example the casing 1 of the electric motor and the shaft 2 of the rotor.

As illustrated, the bushing bearing assembly 30 comprises an annular layer 35 of expandable material radially located between the outer cylindrical surface 31a of the ring 31 and the cylindrical bore 1a of the casing 1.

The layer 35 is made of a material having the properties to expand when the temperature T reaches the first temperature threshold T₁, for example a temperature comprised between 80° C. and 95° C., for example of 90° C., to reach its plastically deformation when the temperature reaches the second temperature threshold T₂, for example a temperature comprised between 120° C. and 135° C., for example of 130° C., and to rupture when the temperature reaches the third temperature threshold T₃, for example a temperature higher than 200° C.

As an alternative, the layer 35 may have the shape of a toroidal ring and be located in one or two grooves provided on the outer surface 31a of the ring 31.

The layer 35 has the same thermal properties and characteristics as the layer 15 of FIG. 1.

The layers of expandable material shown in FIGS. 1 to 5 can have the shape of an annular ring or can be a portion of an annular ring or a plurality of portions of an annular ring radially spaced.

Thanks to the invention and to the thermal properties of the layer of expandable material, at least one ring of the bearing assembly is permanently assembled with the casing or the shaft of the motor. The rings bearing assembly are not subjected to rotate relatively to the component to be assembled with. Moreover, the bearing assembly is easily dissembled from the components supporting the bearing assembly by heat treatment until a temperature threshold allowing the layer of expandable material to rupture. The volume of the expanded layer is thus decreased.

Furthermore, the layer of expandable material has damping properties such that noise and vibrations of the shaft are damped.

1. A bearing assembly comprising at least one ring arranged between first and second components, the second component being mounted for rotation relative to the first component wherein the bearing assembly comprises at least one layer of expandable material disposed radially between a first ring of said at least one ring and one of said first and second components, said at least one layer of expandable material having been irreversibly expanded by a heat treatment at a temperature above a first temperature threshold.

2. The bearing assembly according to claim 1, wherein said first ring comprises at least one cylindrical groove in a cylindrical surface and wherein the at least one layer of expandable material is disposed in said at least one cylindrical groove.

3. The bearing assembly according to claim 2, wherein said at least one cylindrical groove comprises at least two cylindrical grooves and wherein the at least one layer of expandable material is disposed in each of said at least two cylindrical grooves.

4. The bearing assembly according to claim 1, including rolling elements located between said first ring and the second component.

5. The bearing assembly according to claim 1, wherein said first ring comprises an outer ring and wherein a second ring of said at least one ring comprises an inner ring and including rolling elements disposed between a raceway of said inner ring and a raceway of said outer ring.

6. The bearing assembly according to claim 1, wherein said at least one layer of expandable material substantially covers an entire cylindrical surface of said first ring.

7. The bearing assembly according to claim 1, wherein the at least one layer of expandable material comprises a shell and a fluid encapsulated inside said shell, said fluid being configured to expand in response to increased temperature, said shell being configured to deform in a non-reversible way when a temperature reaches the first temperature threshold and said shell being configured to rupture when the temperature reaches a second temperature threshold greater than said first temperature threshold.

8. The bearing assembly according to claim 7, wherein the first temperature threshold is between 120° C. and 135° C., and the second temperature threshold is higher than 200° C.

9. An electric motor comprising a casing, a rotor rotatably mounted in said casing and at least one bearing assembly according to claim 1 arranged between the casing and the rotor.

10. A method of assembling a bearing assembly comprising at least one ring arranged between first and second components the second component being mounted for rotation relative to the first component, the method comprising the steps of positioning a layer of expandable material radially between the at least one ring of said bearing assembly and the first component and heating the layer of expandable material until a temperature threshold is reached at which temperature threshold the layer of expandable material deforms in a non-reversible way.

11. The method according to claim 10, wherein the layer of expandable material comprises a shell and a fluid in the shell, the method including heating the fluid to expand the fluid and stretch the shell before the temperature threshold is reached.

12. The method according to claim 11, including heating the layer of expandable material until the shell ruptures.

13. The bearing assembly according to claim 1,
wherein said at least one layer of expandable material substantially covers an entire cylindrical surface of said first ring,
wherein the at least one layer of expandable material comprises a shell and a fluid encapsulated inside the shell, the fluid being configured to expand in response to increased temperature, the shell being configured to deform in a non-reversible way when a temperature reaches the first temperature threshold and the shell being configured to rupture when the temperature reaches a second temperature threshold greater than the first temperature threshold, and
wherein the first temperature threshold is between 120° C. and 135° C., and the second temperature threshold is higher than 200° C.

14. A bearing assembly comprising:
a first component;
a second component mounted for rotation relative to the first component;
a bearing outer ring mounted to the first component;
a bearing inner ring mounted to the second component; and
a layer of expandable material between the bearing outer ring and the first component, the layer of expandable material being reversibly deformable at temperatures below a temperature threshold and ceasing to be reversibly deformable after the temperature threshold has been exceeded.

15. The bearing assembly according to claim 14, wherein the layer of expandable material has been raised to a temperature above the temperature threshold and has ceased to be reversibly deformable.

16. The bearing assembly according to claim 15, wherein the layer of expandable material comprises a shell and a fluid in the shell.
